(19) United States
(12) Patent Application Publication
(10) Pub. No.: US 2023/0169172 A1
(43) Pub. Date: Jun. 1, 2023

(54) RESILIENT SOFTWARE UPDATE ARCHITECTURE FOR EMBEDDED SYSTEMS

(71) Applicant: Infinera Corp., San Jose, CA (US)

(72) Inventors: Bryce Edwards, Sunnyvale, CA (US); Wayne Johnson, Santa Clara, CA (US); Yatindra Chugh, Sunnyvale, CA (US); Ramanujan Puranam, San Jose, CA (US)

(21) Appl. No.: 18/059,738

(22) Filed: Nov. 29, 2022

Related U.S. Application Data
(60) Provisional application No. 63/283,721, filed on Nov. 29, 2021.

(51) Int. Cl. G06F 21/57; G06F 8/654; G06F 21/44

(52) U.S. Cl. CPC G06F 21/572; G06F 8/654; G06F 21/44; G06F 2221/033

(57) ABSTRACT

A network element is described herein. The network element comprises an embedded device having a processor; a communication device; a first memory having a first firmware; and a second memory having a boot data, a first system partition, a second system partition, a download partition, and a data partition, the second memory storing a software application having software components and a processing sequence comprising first computer-executable instructions that when executed by the processor cause the processor to: store an update package in the download partition, the update package comprising second computer-executable instructions and a firmware package having a firmware update; install the update package to the second system partition; update the first firmware with the firmware update; reload the first firmware; mark the second system partition as an active partition; and reboot into the active partition.

### CROSS-REFERENCE TO RELATED APPLICATION/INCORPORATION BY REFERENCE

This application claims priority to U.S. Provisional Patent Application No. 63/283,721, filed Nov. 29, 2021, the entire content of which is incorporated herein by reference in its entirety.

### BACKGROUND

Optical communication systems typically include a first node that supplies optical signals carrying user information or data to a second node that receives such optical signals via an optical communication path that connects the first node to the second node. In certain optical communication systems, the first node is a so-called hub node that communicates with a plurality of second nodes, also referred to as leaf nodes. The optical communication paths that connect the hub with multiple leaf nodes may include one or more segments of optical fiber connected to one another by various optical components or sub-systems, such as optical amplifiers, optical splitters and combiners, optical multiplexers and demultiplexers, and optical switches, for example, wavelength selective switches (WSS). The optical communication path and its associated components may be referred to as a line system.

In each node, the various optical components or sub-systems and the various electrical components and subsystems may each include at least one microprocessor and each node may include at least one processor communicating with each microprocessor. Software development and board bring-up time is proportional to the number of microprocessors in an embedded system. Communication between the microprocessors and the software stack is fundamental for a quick bring-up and successful runtime of the node.

What the various optical components or sub-systems are updated, operations and communications between components of each board in the node. Moreover, if a reboot is required to install the update, the board may not be able to communicate with other components of the node while the update occurs prior to completion of the boot process or shut-down process.

The delayed update install process restricting communication between the board and other components of the node impacts existing services executing on the node causing delays and longer down-time between operations. And if the update install requires more than one reboot process, these impacts and delays are even further exacerbated.

Therefore, a need exists for systems and methods for installing system updates on embedded devices of optical network nodes while minimizing impacts and delays due to install downtimes. It is to such systems and methods the present disclosure is directed.

### SUMMARY

The problems of the conventional methodologies for booting embedded systems are addressed by the network element disclosed herein. The network element comprises an embedded device having a processor; a communication device in communication with the processor of the embedded device and operable to communicate via a communication network; a first memory, the first memory being a non-transitory computer-readable medium having a first firmware; and a second memory, the second memory being a non-transitory computer-readable medium having a boot data, a first system partition, a second system partition, a download partition, and a data partition, the second memory storing a software application having software components and a processing sequence comprising first computer-executable instructions. The first computer-executable instructions, when executed by the processor, cause the processor to: store an update package in the download partition, the update package comprising second computer-executable instructions and a firmware package having a firmware update; install the update package to the second system partition; update the first firmware in the first memory with the firmware update; reload the first firmware in the first memory; mark the second system partition as an active partition, the active partition being a data indicative of the second system partition having the software application to be executed by the processor; and reboot into the active partition.

In another aspect, in accordance with some implementations, the disclosure describes a method. The method comprises: storing, by an embedded device a firmware in a first memory, an update package in a second memory, the update package comprising first computer-executable instructions and a firmware package having a firmware update, the embedded device further comprising a processor executing second computer-executable instructions stored in a third memory; installing, by the processor, the first computer-executable instructions of the update package to a fourth memory of the embedded device; updating the firmware in the first memory with the firmware update from the update package; reloading the firmware in the first memory; marking the fourth memory as an active device memory and the third memory as a standby device memory; and rebooting into the active device memory such that the processor executes the first computer-executable instructions installed in the fourth memory of the embedded device.

Implementations of the above techniques include methods, apparatus, systems, and computer program products. One such computer program product is suitably embodied in a non-transitory machine-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of a computer system constructed in accordance with the present disclosure and configured with a resilient software update architecture;

FIG. 2 is a diagram of an exemplary embodiment of a user device of the computer system shown in FIG. 1;

FIG. 3 is a diagram of an exemplary embodiment of an update server of the computer system shown in FIG. 1;

FIG. 4A is a diagram of an exemplary embodiment of a network element of the computer system shown in FIG. 1;

FIG. 4B is a diagram of an exemplary embodiment of an embedded device of the network element system shown in FIG. 4A;

FIG. 5 is a diagram of an exemplary embodiment of a processing sequence constructed in accordance with the present disclosure;

FIG. 6 is a diagram of an exemplary embodiment of the update service constructed in accordance with the present disclosure; and

FIG. 7 is a process flow diagram of an exemplary embodiment of an update process according to the present disclosure.

### DETAILED DESCRIPTION

The following detailed description of example embodiments refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

Software may include one or more computer readable instruction that when executed by one or more component, e.g., a processor, causes the component to perform a specified function. It should be understood that the algorithms described herein may be stored on one or more non-transitory computer readable medium. Exemplary non-transitory computer readable mediums may include random-access memory (RAM), a read only memory (ROM), and/or a non-volatile memory such as, for example, a CD-ROM, a hard drive, a solid-state drive, a flash drive, a memory card, a DVD-ROM, a Blu-ray Disk, a disk, an optical drive, combinations thereof, and/or the like.

Such non-transitory computer readable media may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

As used herein, a “route” and/or an “optical route” may correspond to an optical path and/or an optical light path. For example, an optical route may specify a path along which light is carried between two or more network entities along a fiber optic link, e.g., an optical fiber.

As used herein, an optical data link may be an optical channel, an optical super-channel, a super-channel group, an optical carrier group, a set of spectral slices, an optical control channel (e.g., sometimes referred to herein as an optical supervisory channel, or an “OSC”), an optical data channel (e.g., sometimes referred to herein as “BAND”), and/or any other optical signal transmission link.

In some implementations, an optical data link may be an optical super-channel. A super-channel may include multiple channels multiplexed together using wavelength-division multiplexing in order to increase transmission capacity. Various quantities of channels may be combined into super-channels using various modulation formats to create different super-channel types having different characteristics. Additionally, or alternatively, an optical data link may be a super-channel group. A super-channel group may include multiple super-channels multiplexed together using wavelength-division multiplexing in order to increase transmission capacity.

Additionally, or alternatively, an optical data link may be a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 382 spectral slices, where each spectral slice may represent 12.5 GHz of the 4.8 THz spectrum. A super-channel may include a different quantity of spectral slices depending on the super-channel type.

The generation of laser beams for use as optical data carrier signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

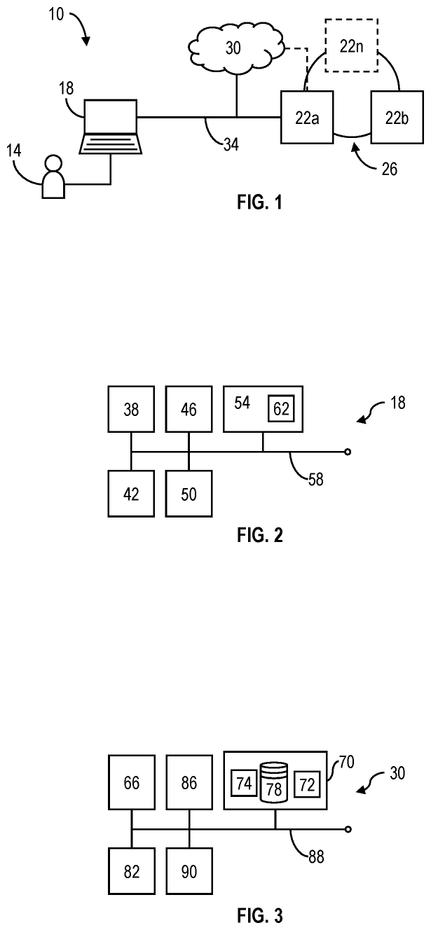

Referring now to the drawings, and in particular to FIG. 1, shown therein is a diagram of an exemplary embodiment of a computer system 10 constructed in accordance with the present disclosure. A user 14 may interact with the computer system 10 using a user device 18 that may be used to communicate with one or more network element 22a-n (hereinafter “network element 22”) or an update server 30 of a transport network 26 (e.g., a first network element 22a, a second network element 22b), via a communication network 34.

In some embodiments, the update server 30 may comprise a processor and a memory having a data store that may store data such as an update package, system version information, network element version information, firmware version information, sensor data, system data, metrics, logs, tracing, and the like in a raw format as well as transformed data that may be used for tasks such as reporting, visualization, analytics etc. The data store may include structured data from relational databases, semi-structured data, unstructured data, time-series data, and binary data. The data store may be a data base, a remote accessible storage, or a distributed filesystem. In some embodiments, the data store may be a component of an enterprise network.

In some embodiments, the update server 30 is connected to the transport network 26 via the communication network 34. In this way, the update server 30 may communicate with each of the one or more network element 22, and may, via the communication network 34 transmit or receive from each of the one or more network element 22 data. In other embodiments, the update server 30 may be integrated into each network element 22 and/or may communicate with one or more pluggable card within the network element 22. In some embodiments, the update server 30 may be a remote network element 22.

The communication network 34 may be almost any type of network. For example, in some embodiments, the communication network 34 may be a version of an Internet network (e.g., exist in a TCP/IP-based network). In one embodiment, the communication network 34 is the Internet. It should be noted, however, that the communication network 34 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

If the communication network 34 is the Internet, a primary user interface of the computer system 10 may be delivered through a series of web pages or private internal web pages of a company or corporation, which may be written in hypertext markup language, JavaScript, or the like, and accessible by the user device 18. It should be noted that the primary user interface of the computer system 10 may be another type of interface including, but not limited to, a Windows-based application, a tablet-based application, a mobile web interface, a VR-based application, an application running on a mobile device, and/or the like. In one embodiment, the communication network 34 may be connected to one or more of the user device 18, update server 30, and the network elements 22a-n.

The transport network 26 may be, for example, a packet transport network (such as IP, MPLS, or MPLS-TP packet transport networks) and/or an optical transport network (such as OTN or WDM transport networks). The transport network 26 may be considered as a graph made up of interconnected individual nodes (that is, the network elements 22). If the transport network 26 is an optical transport network, the transport network 26 may include any type of network that uses light as a transmission medium. For example, the transport network 26 may include a fiber-optic based network, an optical transport network, a light-emitting diode network, a laser diode network, an infrared network, a wireless optical network, a wireless network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of the computer system 10 may perform one or more functions described as being performed by another one or more of the devices of the computer system 10. Devices of the computer system 10 may interconnect via wired connections, wireless connections, or a combination thereof. For example, in one embodiment, the user device 18 and the update server 30 may be integrated into the same device, that is, the user device 18 may perform functions and/or processes described as being performed by the update server 30, described below in more detail.

Referring now to FIG. 2, shown therein is a diagram of an exemplary embodiment of the user device 18 of the computer system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the user device 18 may include one or more user input device 38 (hereinafter “user input device 38”), one or more user output device 42 (hereinafter “user output device 42”), one or more user processor 46 (hereinafter “user processor 46”), one or more user communication device 50 (hereinafter “user communication device 50”) capable of interfacing with the communication network 34, one or more non-transitory computer readable medium 54 (hereinafter “user memory 54”) storing processor-executable code and/or software application(s), for example including, a web browser capable of accessing a website and/or communicating information and/or data over a wireless or wired network (e.g., the communication network 34), and/or the like. The user input device 38, the user output device 42, the user processor 46, the user communication device 50, and the user memory 54 may be connected via a path 58 such as a data bus that permits communication among the components of the user device 18.

The user memory 54 may store a user application 62 that, when executed by the user processor 46, causes the user device 18 to perform an action such as communicate with or control one or more component of the user device 18, the transport network 26 (e.g., the one or more network element 22) and/or the communication network 34.

The user input device 38 may be capable of receiving information input from the user 14 and/or the user processor 46, and transmitting such information to other components of the user device 18 and/or the communication network 34. The user input device 38 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The user output device 42 may be capable of outputting information in a form perceivable by the user 14 and/or the user processor 46. For example, implementations of the user output device 42 may include, but are not limited to, a computer monitor, a screen, a touchscreen, a speaker, a website, a television set, a smart phone, a PDA, a cell phone, a fax machine, a printer, a laptop computer, a haptic feedback generator, combinations thereof, and the like, for example. It is to be understood that in some exemplary embodiments, the user input device 38 and the user output device 42 may be implemented as a single device, such as, for example, a touchscreen of a computer, a tablet, or a smartphone. It is to be further understood that as used herein the term “user 14” is not limited to a human being, and may comprise a computer, a server, a website, a processor, a network interface, a user terminal, a virtual computer, combinations thereof, and/or the like, for example.

The communication network 34 may permit bi-directional communication of information and/or data between the user device 18 and/or the network elements 22 of the transport network 26. The communication network 34 may interface with the user device 18 and/or the network elements 22 in a variety of ways. For example, in some embodiments, the communication network 34 may interface by optical and/or electronic interfaces, and/or may use a plurality of network topographies and/or protocols including, but not limited to, Ethernet, TCP/IP, circuit switched path, combinations thereof, and/or the like. The communication network 34 may utilize a variety of network protocols to permit bi-directional interface and/or communication of data and/or information between the user device 18 and/or the network elements 22.

In one embodiment, the user 14, through the user device 18, may communicate with the update server 30 and schedule one or more update task on the update server 30. The update task may be scheduled to execute on the update server 30 and may repeat periodically or may be a single-occurrence task.

Referring now to FIG. 3, shown therein is a diagram of an exemplary embodiment of the update server 30 constructed in accordance with the present disclosure. In the illustrated embodiment, the update server 30 is provided with one or more server processor 66 (hereinafter “server processor 66”), one or more server memory 70 (hereinafter “server memory 70”) storing cloud server software 74 and one or more server database 78 (hereinafter “server database 78”). The server memory 70 may be a non-transitory computer readable storage medium accessible by the server processor 66 of the update server 30. In some embodiments, the server database 78 may be a time series database. The server database 78 may be a relational database or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The server database 78 can be centralized or distributed across multiple systems.

In some embodiments, the server processor 66 may comprise one or more server processor 66 working together, or independently, to read and/or execute processor executable code, such as the cloud server software 74. The server processor 66 may be capable of creating, manipulating, retrieving, altering, and/or storing data structures into the server memory 70. Additionally, each update server 30 may include at least one server input device 82 (hereinafter “server input device 82”) and at least one server output device 86 (hereinafter “server output device 86”). Each element of the update server 30 may be partially or completely network-based or cloud-based, and may or may not be located in a single physical location.

Exemplary embodiments of the server processor 66 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The server processor 66 may be capable of communicating with the server memory 70 via a path 88 (e.g., data bus). The server processor 66 may be capable of communicating with the server input device 82 and/or the server output device 86.

The server processor 66 may be further capable of interfacing and/or communicating with the user device 18 and/or the network elements 22 via the communication network 34 using a server communication device 90. For example, the server processor 66 may be capable of communicating via the communication network 34 by exchanging signals (e.g., analog, digital, optical, and/or the like) via one or more ports (e.g., physical or virtual ports) using a network protocol to provide updated information to the user device 18.

The server memory 70 may be implemented as a conventional non-transitory computer readable medium, such as for example, random access memory (“RAM”), CD-ROM, a hard drive, a solid-state drive, a flash drive, a memory card, a DVD-ROM, a disk, an optical drive, combinations thereof, and/or the like, for example.

In some embodiments, the server memory 70 may be located in the same physical location as the update server 30, and/or one or more server memory 70 may be located remotely from the update server 30. For example, the server memory 70 may be located remotely from the update server 30 and communicate with the server processor 66 via the communication network 34. Additionally, when more than one server memory 70 is used, a first server memory 70 may be located in the same physical location as the server processor 66, and additional server memory 70 may be located in a location physically remote from the server processor 66. Additionally, the server memory 70 may be implemented as a “cloud” non-transitory computer readable storage memory (i.e., one or more server memory 70 may be partially or completely based on or accessed using the communication network 34).

The server input device 82 may transmit data to the server processor 66 and may be similar to the user input device 38. The server input device 82 may be located in the same physical location as the server processor 66, or located remotely and/or partially or completely network-based. The server output device 86 may transmit information from the server processor 66 to the user 14, and may be similar to the user output device 42. The server output device 86 may be located with the server processor 66, or located remotely and/or partially or completely network-based.

The server memory 70 may store processor executable code and/or information comprising the server database 78 and cloud server software 74. In some embodiments, the cloud server software 74 may be stored as a data structure, such as the server database 78 and/or data table, for example, or in non-data structure format such as in a non-compiled text file. In some embodiments, the server memory 70 may store one or more update package 72 (hereinafter “update package 72”).

The one or more update package 72 may include, for example, computer-executable code having an update type comprising one or more of a full update, a delta update, and/or a firmware update. In one embodiment, the update package 72 further includes a signature information indicative of at least one of an integrity and an authenticity of the update package 72. In some embodiments, the signature information is a checksum or a digital signature. In one embodiment, the signature information may be included for each update of the update package 72.

In one embodiment, the update package 72 may be a software stack to install on a target system (such as the network element 22, and/or a component thereof as described below in more detail). The update package 72, having the update type of a full update, may comprise a full software stack running on the target system, including one or more software update for an operating system, an infrastructure package, a security package, a firmware package, host application processes, microservices, and the like, or some combination thereof.

In one embodiment, the update package 72 may be a software stack to install on the target system (such as the network element 22, and/or a component thereof). The update package 72, having the update type of a delta update, may comprise a limited software scope so as to update a minimum set of sub-packages on the target system. Generally, the delta update delivers one or more software update over an existing installation. The delta update may be a first delta update wherein the update package 72 comprises all package dependencies but does not require re-installation of the full software stack running on the target system, or the delta update may be a second delta update wherein the update package 72 comprises only component packages having an update or modification, such as microservices and firmware packages, thereby decreasing the update package 72 size and reducing downtime to only the component packages having the update or modification.

The network elements 22 may include one or more devices that gather, process, store, and/or provide information in response to a request in a manner described herein. For example, the network elements 22 may include one or more optical data processing and/or traffic transfer devices, such as an optical node, an optical amplifier (e.g., a doped fiber amplifier, an erbium doped fiber amplifier, a Raman amplifier, etc.), an optical add-drop multiplexer (“OADM”), a reconfigurable optical add-drop multiplexer (“ROADM”), a flexibly reconfigurable optical add-drop multiplexer module (“FRM”), an optical source component (e.g., a laser source), an optical source destination (e.g., a laser sink), an optical multiplexer, an optical demultiplexer, an optical transmitter, an optical receiver, an optical transceiver, a photonic integrated circuit, an integrated optical circuit, a computer, a server, a router, a bridge, a gateway, a modem, a firewall, a switch, a network interface card, a hub, and/or any type of device capable of processing and/or transferring optical traffic.

In some implementations, the network element 22 may include OADMs and/or ROADMs capable of being configured to add, drop, multiplex, and demultiplex optical signals. The network elements 22 may process and transmit optical signals to other network elements 22 throughout the transport network 26 in order to deliver optical transmissions.

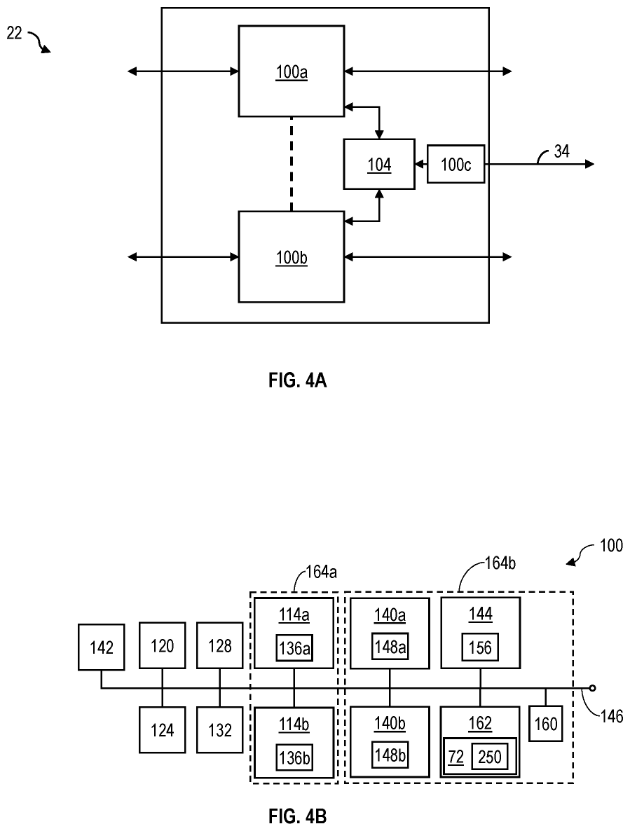

Referring now to FIG. 4A, shown therein is a diagram of an exemplary embodiment of the network element 22, such as the first network element 22a and/or the second network element 22b of FIG. 1, constructed in accordance with the present disclosure. The network element 22 generally comprises an embedded device 100 (shown as embedded devices 100a-c), a communication device 104 to allow one or more component of the network element 22 to communicate to one or more other component of the network element 22 or via the communication network 34, e.g., to another network element 22 in the computer system 10 or the update server 30.

In one embodiment, the embedded device 100 includes one or more digital coherent optics module having one or more coherent optical transceiver operable to receive client data from an electrical signal and transmit the client data in an optical signal and/or receive the client data from an optical signal and transmit the client data in an electrical signal, or a combination thereof. In one embodiment, the embedded device 100 may include one or more of the Layer 1 elements and/or Layer 0 elements as detailed above. The embedded optical device may have one or more property affecting a function of the embedded device and one or more status indicative of a current state of at least one component of the embedded device.

In accordance with the present disclosure, the network element 22 may be a holder, like a chassis or rack, or a contained/logical equipment, like an optical line card within the chassis. In one embodiment, the network element 22 may be a logical entity comprising one or more chassis having one or more pluggable cards (such as one or more embedded device 100) that form the network element 22. For instance, pluggable cards may include traffic carrying (“data plane”) cards (e.g., embedded device 100) that may have customized silicon such as ASICs or FPGAs that process the data plane frames/packets, based on the functionality of the card. Another exemplary traffic carrying card is a router line-card which has packet processing ASICs or other specialized silicon. Another exemplary embedded device 100 is an optical line card that includes a DSP module and/or optical photonic circuits. Pluggable cards may also refer to controller cards (“control and management plane”) that do not process data packets but run all the software that implement the control plane (routing protocols) and management plane (management interfaces such as CLI, NETCONF, gRPC, DHCP etc.) such as the controller card (shown as embedded device 100c). The embedded device 100c typically has an off-the-shelf CPU (such as Intel or ARM) and run some variant of an operating system (e.g., Linux, QNX, Unix, FreeRTOS, FreeBSD, or BSD), described below in more detail. Other embedded devices 100 include common cards that may also be added such as fan trays, power entry modules, and others that provide auxiliary functions of the chassis.

It should be noted that the diagram of the network element 22 in FIG. 4A is simplified to include one embedded device 100c in communication with multiple embedded devices 100a-b. It is understood that the network element 22 may include more than one embedded device 100c (e.g., controller card), and each embedded device 100c may be in communication with one or more embedded device 100 via the same or a different communication device 104.

The number of devices illustrated in FIG. 4A is provided for explanatory purposes. In practice, there may be additional devices, fewer devices, different devices, or differently arranged devices than are shown in FIG. 4A. Furthermore, two or more of the devices illustrated in FIG. 4A may be implemented within a single device, or a single device illustrated in FIG. 4A may be implemented as multiple, distributed devices. Additionally, one or more of the devices illustrated in FIG. 4A may perform one or more functions described as being performed by another one or more of the devices illustrated in FIG. 4A. Devices illustrated in FIG. 4A may interconnect via wired connections (e.g., fiber-optic connections).

Referring now to FIG. 4B, shown therein is a diagram of an exemplary embodiment of the embedded device 100 constructed in accordance with the present disclosure. In some embodiments, the embedded device 100 may include, but is not limited to, one or more input device 120 (hereinafter “input device 120”), one or more output device 124 (hereinafter “output device 124”), one or more processor 128 (hereinafter “processor 128”), one or more communication device 132 (hereinafter “communication device 132”) operable to interface with the communication device 104, a first firmware memory 114a, a first device memory 140a, an immutable memory 142, and a data memory 144. The input device 120, the output device 124, the processor 128, the communication device 132, the first firmware memory 114a, the first device memory 140a, and the data memory 144 may be connected via a path 146 such as a data bus that permits communication among the components of the embedded device 100.

The input device 120 may be capable of receiving client data and transmitting the client data to other components of the computer system 10. The input device 120 may include, but is not limited to, implementation as an optical network interface, an electrical network interface, combinations thereof, and/or the like, for example.

The output device 124 may be capable of outputting client data. For example, implementations of the output device 124 may include, but are not limited to, implementation as an optical network interface, an electrical network interface, combinations thereof, and/or the like, for example.

In one embodiment, the immutable memory 142 may store an immutable firmware, i.e., the immutable firmware cannot be updated or changed. The immutable memory 142 may store computer-executable instructions that are executed as soon as the embedded device 100 boots and establishes a boot order, e.g., instantiating a bootloader, instantiating a kernel, and instantiating the firmware 136.

The first firmware memory 114a may be a non-transitory computer-readable medium storing computer executable instructions that when executed by a processor causes the processor to perform one or more action. The first firmware memory 114a may store one or more first firmware 136a (hereinafter “first firmware 136a”). The first firmware 136a may be a software that is programmed to interface directly with one or more hardware component of the network element 22. Generally, the first firmware memory 114a has read-only permissions. The first firmware 136a may be provided with firmware signature information indicative of at least one of an integrity and an authenticity of the first firmware 136a. In some embodiments, the firmware signature information is a checksum. In some embodiments, the firmware validity information is a digital signature.

The first device memory 140a may be a non-transitory computer-readable medium storing computer executable instructions that when executed by the processor 128 causes the processor 128 to perform one or more action. The first device memory 140a may store one or more first software application 148a (hereinafter “first software application 148a”). Generally, the first device memory 140a has read-only permissions during normal operation of the embedded device 100, whereas while performing an update, the first device memory 140a may be modified to for read/write permissions. In some embodiments, an ACL us used such that different access control may be provided during an update than during normal operation.

The first software application 148a may be one or more software application provided with software signature information indicative of at least one of an integrity and an authenticity of the first software application 148a. In some embodiments, the software signature information is a checksum. In some embodiments, the software validity information is a digital signature.

In one embodiment, the embedded device 100 further comprises a second firmware memory 114b and a second device memory 140b. The second firmware memory 114b may store one or more second firmware 136b (hereinafter “second firmware 136b”). The second firmware 136b may be a software that is programmed to interface directly with one or more hardware component of the network element 22. Generally, the second firmware memory 114b has read-only permissions. The second device memory 140b may store one or more second software application 148b (hereinafter “second software application 148b”). Generally, the second device memory 140b has read-only permissions during normal operation of the embedded device 100, whereas while performing an update, the second device memory 140b may be modified to for read/write permissions. In some embodiments, an ACL us used such that different access control may be provided during an update than during normal operation.

In one embodiment, the device memories 140 (e.g., the first device memory 140a and the second device memory 140b) each maintain a copy of the software application 148. When not performing an update process, the software application 148 in each device memory 140 is the same, that is, the first software application 148a and the second software application 148b are identical to each other. In this manner, if a particular node memory is compromised, the embedded device 100 can be rebooted into a different node memory to revert any changes to the software application 148. For example, if the first device memory 140a is compromised, the first device memory 140a may be set as a failed memory or standby memory and the second device memory 140b may be set as an active device memory. Once the embedded device 100 is rebooted into the active device memory (e.g., the second device memory 140b), the processor 128 may cause the first device memory 140a to be formatted and the second software application 148b to be copied and/or installed onto the first device memory 140a as the first software application 148a. In this way, there is always at least one bootable memory/partition. The active device memory may thus identify which device memory 140 stores the software application 148 and is accessed by the processor 128 during operation of the embedded device 100.

In one embodiment, the device memories 140 (e.g., the first device memory 140a and the second device memory 140b) are each marked as read-only memories/partitions and are part of the root security group, thereby decreasing the chance that the first device memory 140a and/or the second device memory 140b can be compromised during run-time (i.e., while the embedded device is powered on and the update process is not running).

In one embodiment, the data memory 144 of the embedded device 100 is a non-transitory computer-readable medium storing computer-executable instructions and/or device data 156. The device data 156 comprise one or more file, database, and/or raw data and may include one or more application data, system data, logging data, operational data, configuration file, database, data schema package, and/or the like. For example, the device data 156 may comprise any and/or all read/write access data accessible by the processor 128. In one embodiment, the device data 156 further includes any meta-data and/or files generated by the embedded device 100 such as runtime data including (debugging/status/historic/performance/error/warning/etc.) logs. In some embodiments, the data memory 144 may be referred to as the user partition and has read/write permissions.

In one embodiment, the data memory 144 stores device data 156 that includes one or more read/write file/folder/directory accessible by an active device memory. The data memory 144 may be bound and mounted in a filesystem on the active device memory. For example, the data memory 144 may be bound and mounted on a /opt/data directory in the active device memory. The active device memory may then establish the /opt/data directory as a container volume (e.g., a volume in a container application such as Docker (Docker, Inc., Palo Alto, Calif.), kubernetes (Cloud Native Computing Foundation/The Linux Foundation, San Francisco, Calif.), LXC (sponsored by Canonical Ltd., Isle of Man), and the like) accessible from a container built from a container image. That is, a container (executing a container image) running from the active device memory may access the device data 156 stored on the data memory 144 through the container volume as though the device data 156 is local to the software application 148 (i.e., in the active device memory). In this way, the software application 148 executing in the (read-only) device memory 140 may access and store application data and service data that is persistent between execution of either the first device memory 140a and the second device memory 140b.

In one embodiment, the embedded device 100 further comprises a boot memory 160, or a boot partition. The boot memory 160 is a non-transitory computer-readable medium storing one or more boot data. The boot data may include, for example, a node memory status and a firmware memory status. The node memory status may be a data indicative of which of the device memories 140 (e.g., the first device memory 140a and the second device memory 140b) is an active device memory, a standby device memory, and/or a faulty node memory, for example. The firmware memory status may be a data indicative of which firmware memory 114 (e.g., the first firmware memory 114a and the second firmware memory 114b) is an active firmware memory, a standby firmware memory, and/or a faulty firmware memory, for example. In one embodiment, the boot memory 160 may include a master boot record (MBR) and/or a boot loader.

In one embodiment, if each device memory 140 is a faulty node memory, the boot memory 160 having the bootloader may cause the embedded device 100 to retrieve a full update package 72 from a network source, e.g., a source accessible via the communication device 104 and/or the communication network 34. The bootloader may store the full update package 72 in a RAM memory device and operate the embedded device 100 from the RAM memory device, e.g., build the root file system in RAM.

In one embodiment, the embedded device 100 further comprises a download memory 162. The download memory 162 is a non-transitory computer-readable medium storing one or more downloaded data. The downloaded data may include, for example, the update package 72. In one embodiment, the download memory 162 is a read-write enabled memory allowing the processor 128 to replace a first update package with a second update package, for example.

While the first firmware memory 114a, the second firmware memory 114b, the first device memory 140a, the second device memory 140b, the data memory 144 and the boot memory 160 are described separately, it should be understood that each memory may be combined with one or more other memory and integrated on the same or separate devices. For example, in one embodiment, the first firmware memory 114a and the second firmware memory 114b are integrated into a first memory device 164a as partitions, while the first device memory 140a, the second device memory 140b, the data memory 144 and the boot memory 160 are integrated into a second memory device 164b as partitions. For example, the first memory device 164a may be a flash memory, a ROM memory, or the like, while the second memory device 164b may be a solid-state memory drive, a hard disk drive, or the like. Additional partitions may be created in either the first memory device 164a or the second memory device 164b.

In one embodiment, for example, the second memory device 164b may include the first device memory 140a as a first system partition, the second device memory 140b as a second system partition, the data memory 144 as a data partition, and the boot memory 160 as a boot partition. In some embodiments, the second memory device 164b may further include a download partition to store the update package 72 prior to install. Each partition may have a particular partition type, such as MBR or GPT and a particular partition format such as FAT16, FAT32, exFAT, NTFS, ext2/3/4, XFS, HPFS, HPFS+, ZFS, and the like. The first system partition and the second system partition may both include a copy of the software application 148 and may be marked read-only. One of the first system partition and the second system partition may be marked as an active system partition (i.e., the system partition from which the software application 148 is currently executing), while the other may be marked as a standby partition. Similarly, the boot partition may be marked read-only. The download partition may be a dedicated partition where the update package 72 is stored prior to install. The data partition may be a dedicated partition where the application data and system data are stored. In one embodiment, each partition on the second memory device 164b is dynamically resizable on demand.

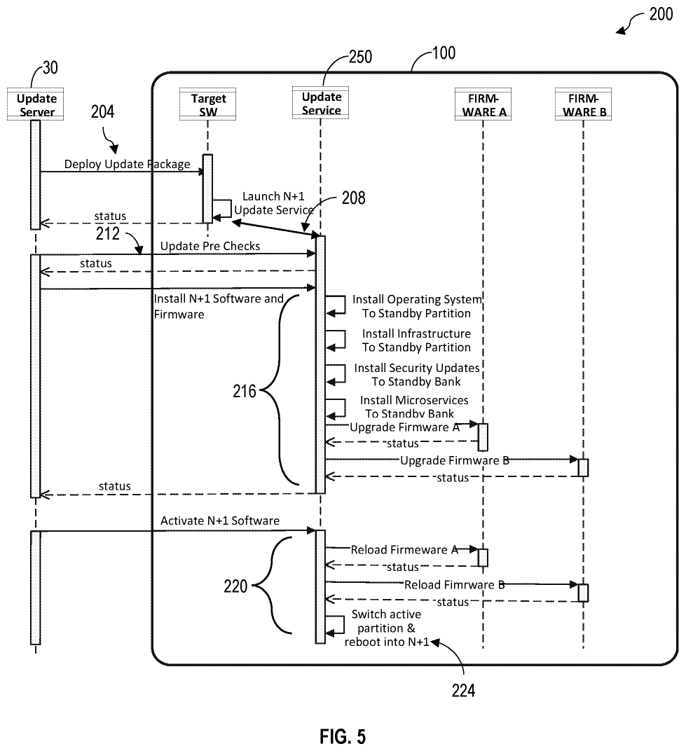

Referring now to FIG. 5, shown therein is a diagram of an exemplary embodiment of a processing sequence 200 constructed in accordance with the present disclosure. The processing sequence 200 generally shows a sequence of steps taken by an update process between the embedded device 100 and the update server 30.

In a first step of the sequence, the update package (e.g., the update package 72) is deployed by the update server 30 to the embedded device 100 (step 204). For example, in one embodiment, the user 14, using the user device 18 may communicate with the update server 30 via the communication network 34, and cause the update server 30 to transmit the update package to the embedded device 100 of a particular network element (e.g., network element 22).

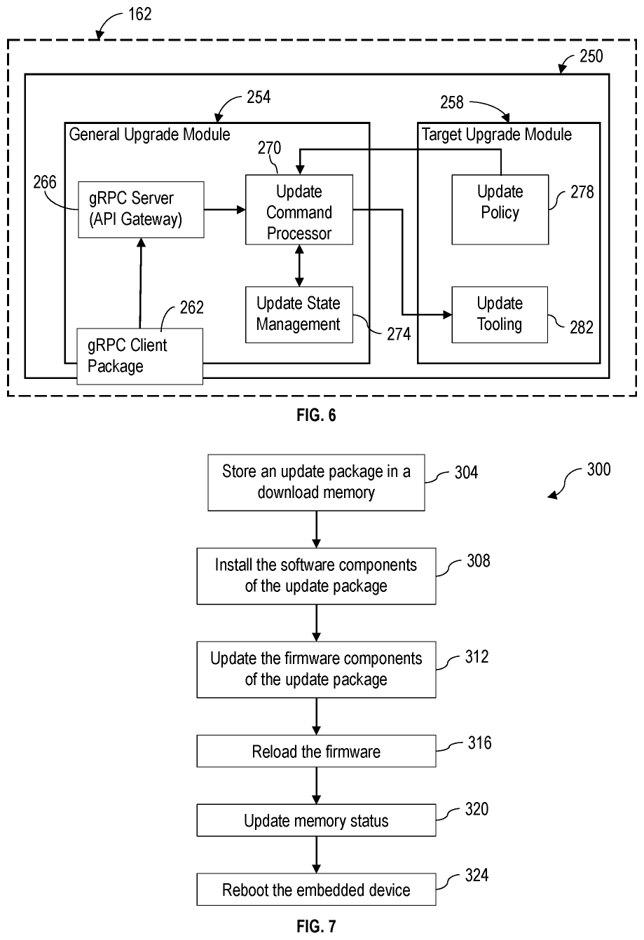

The processor 128 of the embedded device 100 may receive the update package 72 from the update server 30, store the update package 72 in the download memory 162 and extract an update service 250 (shown in FIG. 6) from the update package (step 208). The update service 250 may be a series of computer-executable instructions that cause the processor 128 to begin the update process (detailed below). As discussed above, the update package 72 may be a meta-package having multiple components, including one or more software components, such as an update for an operating system, an infrastructure package, a security package, a host application processes, a microservice package, and the update service 250; a manifest file; a signature file; one or more firmware components, and the like, or some combination thereof. The update package 72 may further comprise one or more data, configuration file, database, data schema package, and/or the like.

In one embodiment, the update service 250 is a stand-alone package that is stored in the update package 72 and contains all required drivers and scripts needed to update the software components in the standby device memory on the embedded device 100. By combining the update service 250 in the update package, the update service 250 may include bug fixes, upgrades, and/or updates made to the update service 250 or other update tools delivered with other components of the update package 72 as shown in FIG. 6 and discussed below in more detail.

In some embodiments, the update package 72 is compressed and/or packaged into a single file, binary executable, or update script. For example, the update package 72 may be compressed into a tar, a zip file, a rar file, and the like. One or more compression and/or encryption algorithm may be applied to the update package to ensure the update package 72 has not been tampered with (either at rest or in transit), that all software components of the update package 72 are included and available at the embedded device 100, and that additional requests for files or further information is not required from the embedded device 100 in order to successfully perform the update process.

In one embodiment, the update package 72 is transmitted to the embedded device 100 as a container image. For example, if the embedded device 100 includes the Docker container application, the update package 72 may be packaged into an update container image. The embedded device 100, then, may, in some embodiments, execute the update container image as the update package. In some embodiments, for example during a delta update to update a first microservice, the delta update package may include a new microservice container image for the first microservice. To update the first microservice, then, the microservice container may be “brought down” (i.e., stopped or terminated), and “brought up” (i.e., re-instantiated, started) pointing to the new microservice container image but maintaining the same container volume parameters.

In some embodiments, update prechecks may be performed (step 212). The update prechecks may include verifying and/or validating information prior to attempting to perform the update process. For example, the update prechecks may include verifying that the embedded device 100 is eligible to perform the update package 72 based on, for example, the current version of software running on the embedded device 100, the location of the embedded device 100, the type of pluggable card or device type of the embedded device 100, and the like. For example, if the update package is specifically targeting optical line cards but the embedded device 100 is a controller card, the update precheck may fail, resulting in termination of the update process.

In other embodiments, the update prechecks may include, for example, verifying the signature information of the update package 72 to verify the update package's authenticity and/or integrity. For example, the processor 128 may perform a checksum measurement on the update package 72 and validate the returned checksum against a known checksum for the update package (e.g., via either the signature file included in the update package, or by requesting the signature file from the update server 30).

The processor 128 of the embedded device 100 may then perform an update install process to install one or more of the packages included in the update package (step 216). In some embodiments, each component of the update package 72 is installed in the order it is listed, while in other embodiments, an install order is included in the update package 72 (e.g., in the manifest file for example). In some embodiments, the one or more software component of the update package is installed prior to installing the one or more firmware component. For example, the operating system may first be installed, followed by the infrastructure package, the security package, the one or more microservice package, and any other software component. Then, the firmware components may be installed such as a firmware update for the first firmware then the firmware update for the second firmware.

In one embodiment, prior to performing the update install process, the processor 128 first identifies which memory to install the update package 72 to. For example, the embedded device 100, being powered on and operating, may have the processor 128 executing computer executable instructions from the active device memory (e.g., one of either the first device memory 140a or the second device memory 140b). When one of either the first device memory 140a or the second device memory 140b is the active device memory, the other may be considered the standby device memory. The processor 128 may thus determine to install the update package 72 first to the standby device memory.

Similarly, the embedded device 100, being powered on and operating, may access one of either the first firmware memory 114a or the second firmware memory 114b as the active firmware memory. When one of either the first firmware memory 114a or the second firmware memory 114b is the active firmware memory, the other firmware memory may be considered the standby firmware memory. The processor 128 may thus determine to install the update package first to the standby firmware memory.

In one embodiment, the active device memory and/or the active firmware memory may be set as a read-only memory prior to the processor 128 executing the update install process, thereby restricting the processor 128 from modifying the active device memory and/or the active firmware memory while the update install process is executing from either of the active device memory or the active firmware memory.

In one embodiment, after the processor 128 has installed the firmware component on the standby firmware memory, the processor 128 may verify that the firmware component has been successfully installed on the standby firmware memory and may set the active firmware memory as a standby firmware memory and the former standby firmware memory (i.e., the firmware memory having the firmware component newly installed) as the active firmware memory. The processor 128 may then install the firmware component on the standby firmware memory as detailed above.

The processor 128 of the embedded device 100 may then prepare the embedded device 100 to execute the newly updated software components (step 220). Preparing the embedded device 100 may include, for example, reloading the active firmware memory, reloading the standby firmware memory, and updating the node memory status of the first device memory 140a and the second device memory 140b. For example, if the first device memory 140a is the active device memory and the second device memory 140b is the standby device memory wherein the update install process has finished installing the update package(s) in the second device memory 140b, then updating the node memory status of the first device memory 140a and the second device memory 140b may include marking the first device memory 140a as the standby device memory and marking the second device memory 140b as the active device memory.

Finally, after the processor 128 has prepared the embedded device 100, the processor 128 may cause the embedded device 100 to reboot into the active device memory and the active firmware memory. When the embedded device 100 has booted into the active device memory (which is now executing the software components received in the update package), the active device memory may access one or more data stored in the data memory 144.

In some embodiments, the update service 250 may report a status back to the update server 30 at various points in the processing sequence 200. For example, after determining update prechecks, after upgrading the software and firmware, and after activating the updated software, or at any other point in the update process when the user 14 may desire a status of the update process. In some embodiments, wherein the user 14 indicates that the user 14 does not desire a status of the update process, the update service 250 may not report the status back to the update server 30.

Referring now to FIG. 6, shown therein is a diagram of an exemplary embodiment of the update service 250 constructed in accordance with the present disclosure. As shown in FIG. 6, the update service 250 generally comprises a general upgrade module 254 and a target upgrade module 258. The update service 250, and each module of the update service 250, may comprise a series of computer-executable instructions and/or configuration that when executed by the processor 128 causes the processor 128 to execute the update process (below).

In one embodiment, the general upgrade module 254 exposes an interface 262 (e.g., a gRPC interface) such that an external entity, for example, an update server 30 (e.g., an update driver), can access and/or control the update service 250 from outside the embedded device 100 via published API 266 to an update control service 270. The update server 30 may access and/or control the update control service 270 via the published API 266 (e.g., a generalized API interface).

In one embodiment, the general upgrade module 254 further comprises an update state management module 274. The update state management module 274 internally manages the state and progress of the update process thereby ensuring consistency of the install of the update package. In one embodiment, the update state management module 274 generates and transmits one or more update status, via the interface 262, to the user device 18 and thus, to the user 14.

In one embodiment, the update state management module 274 is configures to receive a request from the update server 30 to resume an interrupted update and alleviate any need to track a state of the update process externally from the embedded device 100.

In one embodiment, the target upgrade module 258 comprises at least an update policy 278 and an update tool 282. The target upgrade module 258 is specific to the embedded device 100 the upgrade package is targeting, whereas the general upgrade module 254 is included in the update package by default.

The update tool 282 includes tooling for installing the update package specific to the embedded device 100. The tooling may include, for example, specific scripts, drivers, and/or configuration specific to the type of embedded device 100. In some embodiments, the update tool 282 includes an extensible framework to support multiple target types. In one embodiment, the update tool 282 includes one or more docker-compose file operable to instantiate the one or more microservice package of the update package 72 into containerized applications. In one embodiment, the update tool 282 includes prebuild docker images from which to build the docker containers, while ion other embodiments, the update tool 282 includes on or more build file operable to build the docker image from which to instantiate the containers.

The update policy 278 may define a description of the update package being installed. In one embodiment, the update policy 278 informs the update control service 270 how to apply the update tool 282 to the embedded device 100.

In one embodiment, external orchestration policies (e.g., policies received from a processor external to the embedded device 100) can be received by update server 30 to achieve a system level data driven update. In one embodiment, the external orchestration policies may include, for example, user-set parameters affecting one or more aspect of the update service 250. For example, the external orchestration policy may include user-set parameters indicating whether the user 14 desires a status be transmitted by the update service 250. In some embodiments, the external orchestration policies may include user-set parameters affecting whether more than one update occurs at a time, e.g., whether the software application and the firmware may be updated asynchronously or synchronously, for example.

Referring now to FIG. 7, shown therein is a process flow diagram of an exemplary embodiment of an update process 300 constructed in accordance with the present disclosure. The update process 300 generally comprises: storing an update package (step 304); installing software components of the update package (step 308); installing firmware components of the update package (step 312); reloading the firmware (step 316); updating the memory status (step 320); and rebooting the embedded device (step 324). As described above in more detail, the update process 300 may be performed on the embedded device 100 by the processor 128 executing computer-executable instructions.

In one embodiment, storing an update package (step 304) includes saving the update package 72 in the download memory 162. As discussed above in more detail, saving the update package 72 to the download memory 162 may include saving the update package 72 to the download partition.

In one embodiment, installing software components of the update package (step 308) includes unpacking the update package 72 and installing one or more of the operating system package, the infrastructure package, the security package, the host application processes, the microservice package, and the update service 250 to the standby device memory/standby system partition. In some embodiments, the update package 72 includes more than one microservice package.

In one embodiment, installing software components of the update package (step 308) includes determining an order to install the one or more components of the update package 72 as determined by the manifest and/or the update service 250. For example, the update policy 278 and/or the update tool 282 of the target upgrade module 258 of the update service 250 may include one or more computer-executable instruction indicative of an order in which to install the components of the update package 72.

In one embodiment, prior to installing software components of the update package (step 308), the update process 300 may include the step of validating the update package 72. Validating the update package 72 may include validating the signature information of the update package against a known signature to determine at least one of an integrity and an authenticity of the update package 72.

If the signature information (not shown) of a particular package comprises a checksum, the processor 128 may process the update package 72, or a particular software component thereof, using a hash function such as, for example, MD5, SHA-1, SHA-256, combinations thereof, and/or the like. Having processed the update package, the processor 128 may then compare the processed update package with a provided checksum (i.e., signature information). Where the processed update package matches the provided checksum, the processor 128 may continue with the update process 300 and may send data (e.g., a notification or data otherwise determined by the update state management module 274) to the update server 30 indicative of a successful verification, e.g., through the interface 262 via the communications network 34. Where the processed update package does not match the provided checksum, the processor 128 may send data (e.g., a notification) to the update server 30 indicative of a failed verification, e.g., through the interface 262 via the communications network 34.

If the signature information (not shown) of a particular update package comprises a digital signature, the processor 128 may decrypt the digital signature using a public key to generate a decrypted digital signature. Having decrypted the digital signature, the processor 128 may then process the update package (or some component thereof) using a hash function, before comparing the decrypted digital signature with the processed update package. Where the processed update package matches the decrypted digital signature, the processor 128 may send data (e.g., a notification or data otherwise determined by the update state management module 274) to the update server 30 indicative of a successful verification. Where the processed update package does not match the decrypted digital signature, the processor 128 may send data (e.g., a notification) to the update server 30 indicative of a failed verification, e.g., through the interface 262 via the communications network 34.

In one embodiment, installing firmware components of the update package (step 312) may include installing a firmware update from the firmware package from the update package 72 on the standby firmware memory/standby firmware partition. In some embodiments, after the firmware update from the firmware package is installed on the standby firmware memory, the processor 128 may send a notification to the update server 30, e.g., via the interface 262. The notification may be data indicative of at least either a successful install or an unsuccessful install of the firmware update of the firmware package on the standby firmware memory.

In one embodiment, installing firmware components of the update package (step 312) further includes installing the firmware update of the firmware package from the update package 72 stored in the download memory 162 onto the active firmware memory. In some embodiments, the firmware update of the firmware package is installed onto the active firmware memory upon determination if the firmware package was successfully installed on the standby firmware memory. In some embodiments, after the firmware update of the firmware package is installed on the active firmware memory, the processor 128 may send a notification (or data otherwise determined by the update state management module 274) to the update server 30, e.g., via the interface 262. The notification may be data indicative of at least either a successful install or an unsuccessful install of the firmware update on the active firmware memory.

In one embodiment, upon determination that the firmware update was not installed onto the standby firmware memory, the processor 128 may cause the standby firmware memory to be formatted and to attempt to install the firmware update on the standby firmware memory again.

In one embodiment, reloading the firmware (step 316) includes rebooting the embedded device 100 into the active firmware memory to execute the newly installed firmware on the active firmware memory. In other embodiments, the processor 128 may cause the firmware memories to reload sequentially, that is, the processor 128 may cause the first firmware memory to reload/reinitialize at a first time and the second firmware memory to reload/reinitialize as a second time different from the first time.

In one embodiment, prior to reloading the firmware (step 316), the processor 128, via the update service 250, may update the firmware status, i.e., where the first firmware memory is the active firmware memory and the second firmware memory is the standby firmware memory, the processor 128 may update the first firmware memory to the standby firmware memory and the second firmware memory to the active firmware memory.

In one embodiment, updating the memory status (step 320) may include the processor 128, via the update service 250, may include setting the active device memory to the standby device memory and setting the standby device memory to the active device memory. In other words, when the active device memory is the first device memory 140a and the standby device memory is the second device memory 140b, updating the memory status may include setting the first device memory 140a to the standby device memory and setting the second device memory 140b as the active device memory.

In one embodiment, rebooting the embedded device (step 324) includes the processor 128 causing the embedded device 100 to perform a power cycle, that is, shut down and power back on. When rebooting the embedded device, the embedded device 100 will boot into the active device memory. Because the update package 72 was previously installed on the active device memory, the only downtime of the embedded device 100 during the update process 300 is the duration of rebooting the embedded device. The time period it takes to install the update package 72 does not result in the network element 22 or the embedded device 100 being offline during the pendency of the install.

In one embodiment, rebooting the embedded device 100 (step 324) further includes executing a diagnostic upon boot to determine whether the embedded device 100 is functioning appropriately (e.g., is stable) after switching to run on the new active partition (e.g., the second device memory 140b as described above). In some embodiments, the diagnostic is a passive diagnostic, that is, the diagnostic includes monitoring performance of one or more parameter of the embedded device 100 for a predetermined period of time. If all parameters of the embedded device 100 operate within a predefined threshold during the predetermined period of time, the embedded device 100 may be considered stable. The one or more parameters may include, for example, memory utilization (e.g., to identify memory leaks), processor utilization, and/or network utilization (e.g., to identify non-performant software or microservices), embedded device alarms (e.g., indicative of the embedded device 100 having one or more function unavailable that was otherwise available), and/or the like.

In one embodiment, the predetermined period of time to perform the performance monitoring is between 5 minutes and 15 minutes. In other embodiments, the predetermined period of time may be selected based on a likelihood of failure, e.g., if it is determined that, were the embedded device 100 to have a faulty software, there is a 95% chance it would fail (i.e., likelihood of failure) within a particular period of time, then the particular period of time may be used as the predetermined period of time. The likelihood of failure may be used by the user 14 to select the predetermined period of time.

In one embodiment, rebooting the embedded device 100 (step 324) includes installing the update package 72 on the new standby device memory. In this way, installation of any of the update package 72 on the new standby device memory does not require sacrificing uptime of the embedded device 100.

In one embodiment, rebooting the embedded device 100 (step 324) further includes rediscovering the data memory. For example, in one embodiment, rediscovering the data memory includes accessing a bind/mount point (e.g., expected file system location) to identify if the data partition is present. In one embodiment, data for each service package executing within the embedded device 100 is stored on the data memory 144, e.g., as the device data 156. The device data 156 on the data memory 144 may be stored in one or more format discussed above, for example, within a folder structure bound to a container volume.

In one embodiment, after rebooting the embedded device (step 324), the processor 128 (or the update service 250) may ensure that each software component and firmware component, and any other component of, the update package 172 has been successfully installed on the embedded device 100 and that the processor 128 is executing computer-executable instructions from the active device memory. In one embodiment, the processor 128 may send data (e.g., a notification) to the update server 30 indicative of a finalized and successful installation of the update package, e.g., as a data formatted for the published API 266 through the interface 262 via the communications network 34.

The update process 300, as described above, provides for installing an update package in the standby partition thereby installing the update package without requiring the embedded device 100 to reboot, that is, the update package is installed and validated without interrupting operations executing in the active partition. Additionally, the update process 300 provides for installing and validating a firmware update in a standby firmware memory without requiring the embedded device to reboot. In this way, interruptions to operations executing on the embedded device 100 are minimized while both installing and validating the update package.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A network element comprising:
an embedded device having a processor;
a communication device in communication with the processor of the embedded device and operable to communicate via a communication network;
a first memory, the first memory being a non-transitory computer-readable medium having a first firmware; and
a second memory, the second memory being a non-transitory computer-readable medium having a boot data, a first system partition, a second system partition, a download partition, and a data partition, the second memory storing a software application having software components and a processing sequence comprising first computer-executable instructions that when executed by the processor cause the processor to:
store an update package in the download partition, the update package comprising second computer-executable instructions and a firmware package having a firmware update;
install the update package to the second system partition;
update the first firmware in the first memory with the firmware update;
reload the first firmware in the first memory;
mark the second system partition as an active partition, the active partition being a data indicative of the second system partition having the software application to be executed by the processor; and
reboot into the active partition.

2. The network element of claim 1, further comprising first computer-executable instructions that when executed by the processor further cause the processor to:
determine whether the update package on the second system partition is stable if a performance of one or more parameter of the embedded device for a predetermined period of time is below a predefined threshold; and
responsive to a determination that the update package on the second system partition is stable, install the update package to the first system partition.

3. The network element of claim 2, further comprising first computer-executable instructions that when executed by the processor further cause the processor to:
mark the first system partition as a standby partition, the standby partition being a data indicative of the first system partition not being the active partition.

4. The network element of claim 1, wherein the update package further comprises a signature information indicative of at least one of an integrity and an authenticity, and further comprising first computer-executable instructions that when executed by the processor further cause the processor to:
validate the signature information of the update package against a known signature to determine at least one of an integrity and an authenticity of the update package prior to installing the update package.

5. The network element of claim 4, wherein the signature information is at least one of a checksum and a digital signature.

6. The network element of claim 4, wherein upon determining that the signature information is invalid, issue a notification that the signature information is invalid and refrain from installing the update package.

7. The network element of claim 1, wherein the update package further comprises one or more package, the one or more package being one or more of an operating system package, an infrastructure package, a security package, and a microservice package.

8. The network element of claim 7, further comprising first computer-executable instructions that when executed by the processor further cause the processor to:
install each package of the one or more package of the update package.

9. The network element of claim 1, wherein the update package further comprises a signature information indicative of at least one of an integrity and an authenticity, and further comprising:
a third memory, the third memory being a non-transitory computer-readable medium having a second firmware; and
the first computer-executable instructions that when executed by the processor further cause the processor to, prior to reloading the first firmware in the first memory:
determine whether the first firmware in the first memory was successfully updated to the firmware update based at least in part on the signature information; and
upon determination that the first firmware in the first memory was successfully updated to the firmware update, update the second firmware in the third memory with the firmware update.

10. The network element of claim 9, wherein upon determination that the first firmware in the first memory was not successfully updated to the firmware update, format the first memory and copy the second firmware of the third memory to the first memory.

11. The network element of claim 9, wherein the third memory is a non-volatile memory.

12. The network element of claim 9, wherein the first memory and the third memory are integrated into a non-transitory computer-readable medium having a first firmware partition and a second firmware partition, and wherein the first firmware is stored in the first firmware partition and the second firmware is stored in the second firmware partition.

13. The network element of claim 1, wherein the embedded device is a first embedded device, and wherein the network element further comprises one or more second embedded device, wherein the communication network is an optical transport network, and wherein the one or more second embedded device comprises a digital coherent optics module and one or more coherent optical transceiver.

14. The network element of claim 1, wherein the embedded device is a first embedded device, and wherein the network element further comprises one or more second embedded device, wherein the second computer-executable instructions when executed by the processor of the embedded device further cause the embedded device to:
subsequent to rebooting into the second system partition, initialize each of the communication device and the one or more second embedded device.

15. The network element of claim 1, further comprising first computer-executable instructions that when executed by the processor further cause the processor to:
receive the update package from a remote network element in the communication network.

16. The network element of claim 15, wherein the remote network element is an update server.

17. The network element of claim 1, further comprising a third memory comprising the download partition separate from the second memory.

18. The network element of claim 17, wherein the third memory is a random-access memory.

19. A method, comprising:
storing, by an embedded device a firmware in a first memory, an update package in a second memory, the update package comprising first computer-executable instructions and a firmware package having a firmware update, the embedded device further comprising a processor executing second computer-executable instructions stored in a third memory;
installing, by the processor, the first computer-executable instructions of the update package to a fourth memory of the embedded device;
updating the firmware in the first memory with the firmware update from the update package;
reloading the firmware in the first memory;
marking the fourth memory as an active device memory and the third memory as a standby device memory; and
rebooting into the active device memory such that the processor executes the first computer-executable instructions installed in the fourth memory of the embedded device.

20. The method of claim 19, further comprising:
validating the first computer-executable instructions installed in the fourth memory; and
upon determination that the first computer-executable instructions installed in the active device memory are invalid:
marking the active device memory as a failed memory;
marking the standby device memory as the active device memory; and
rebooting into the active device memory such that the processor executes the second computer-executable instructions stored in the third memory.
